(19) United States
(12) Patent Application Publication
(10) Pub. No.: US 2017/0182771 A1
(43) Pub. Date: Jun. 29, 2017

(54) LIQUID DISCHARGE HEAD AND LIQUID DISCHARGE APPARATUS

(71) Applicant: CANON KABUSHIKI KAISHA, Tokyo (JP)

(72) Inventor: Masataka Sakurai, Kawasaki-shi (JP)

(21) Appl. No.: 15/372,245

(22) Filed: Dec. 7, 2016

(30) Foreign Application Priority Data
Dec. 25, 2015 (JP) 2015-254285

(51) Int. Cl. B41J 2/14

(52) U.S. Cl. CPC B41J 2/14088; B41J 2002/14491

(57) ABSTRACT

A liquid discharge head which discharges a liquid, includes, a substrate on which plural heaters configured to generate heat for discharging a liquid are provided, an electroconductive protective film configured to cover the plural heaters and define a group consisting of the covered plural heaters in the substrate, a discrete wiring connected with the protective film for each group in the substrate, a common wiring connected with the discrete wiring for each group in common, and a terminal connected with the common wiring and configured to electrically connect the common wiring with an outside of the substrate, wherein electrical resistance of the discrete wiring is higher than electrical resistance of the common wiring.

### BACKGROUND OF THE INVENTION

Field of the Invention

Embodiments of the present invention generally relate to a liquid discharge head and a liquid discharge apparatus, and more particularly, relate to a liquid discharge head in which an electroconductive protective film provided on a heater which generates heat upon application of a voltage for discharge of a liquid, such as ink, is provided in common to plural heaters.

Description of the Related Art

In an electroconductive protective film formed on plural heaters arranged on a substrate which constitute a liquid discharge head, a common pattern of an electroconductive protective film corresponding to plural heaters is often used. An electrical leakage check between an electroconductive protective film and a heater wiring layer is performed, for example, as an examination after the manufacture of a substrate. The electrical leakage check is performed for the following reason. If an electrical leakage occurs between the electroconductive protective film and a heater wiring layer, oxidization and dissolution of the electroconductive protective film caused by an electrochemical reaction between the electroconductive protective film and the ink due to an influence of a potential for driving the heater drive potential may proceed, and a change in discharge characteristics and defective discharge may be caused. By using a common pattern of the electroconductive protective film, the electrical leakage check on plural heaters can be performed collectively, and therefore the examination can be simplified.

As a form of using a common pattern of an electroconductive protective film, Japanese Patent No. 4995355 describes a configuration of removing kogation adhering on the electroconductive protective film upon discharge of ink by applying an appropriate potential for the electroconductive protective film on the heater and controlling an electrochemical reaction between the electroconductive protective film and the ink. Also in this case, the electrical potential of the electroconductive protective film on plural heaters can be collectively controlled as an electrically common pattern.

In the configuration in which the electroconductive protective film is used in common to the plural heaters, if a leakage occurs between the electroconductive protective film and the heater wiring layer immediately after the manufacture of the substrate, the leakage can be detected in an electrical check before the assembly of the substrate. Therefore, a chip with a leakage can be excluded as a defective chip.

There is a possibility, however, that a leakage may occur in a substrate due to a thermal and mechanical impact etc. during assembly into a discharge head even if the substrate has no leakage immediately after the manufacture of the substrate. Further, even if no leakage occurs after the assembly into the discharge head, a leakage may occur due to a thermal impact, cavitation, etc. during usage of the discharge head for recording, etc. In a configuration in which the electroconductive protective film is used in common to the plural heaters, if a leakage occurs in at least one of the plural heaters, an electrochemical reaction may proceed in the electroconductive protective film on electrically connected other heaters. As a result, a change in discharge characteristics and defective discharge may be caused in nozzles corresponding to these heaters.

### SUMMARY OF THE INVENTION

Embodiments of the present invention provide a liquid discharge head and a liquid discharge apparatus capable of limiting an influence of a leakage, even if a leakage occurs between a heater and an electroconductive protective film after the liquid discharge head is used for recording, etc., and preventing the entire liquid discharge head from becoming defective.

In an aspect of the present invention, a liquid discharge head which discharges a liquid, which includes a substrate on which plural heaters configured to generate heat for discharging a liquid are provided, an electroconductive protective film configured to cover the plural heaters and define a group consisting of the covered plural heaters in the substrate, a discrete wiring connected with the protective film for each group in the substrate, a common wiring connected with the discrete wiring for each group in common, and a terminal connected with the common wiring and configured to electrically connect the common wiring with an outside of the substrate. Electrical resistance of the discrete wiring is higher than electrical resistance of the common wiring.

Further features of the present invention will become apparent from the following description of exemplary embodiments with reference to the attached drawings.

### BRIEF DESCRIPTION OF THE DRAWINGS

FIG. 1A is a plan view and FIG. 1B is an enlarged plan view schematically illustrating a substrate constituting an inkjet recording head according to a first embodiment of the present invention.

FIG. 2A is an enlarged view of a heater group on a substrate of a recording head according to a second embodiment of the present invention and FIG. 2B is a cross-sectional view along line IIB-IIB.

FIG. 3A is an enlarged view of a heater group on a substrate of a recording head according to a third embodiment of the present invention and FIG. 3B is a cross-sectional view along line IIIB-IIIB.

FIG. 4A is a plan view and FIG. 4B is an enlarged plan view schematically illustrating a substrate of a recording head according to a fourth embodiment of the present invention.

FIG. 5 is a plan view schematically illustrating a substrate of a recording head according to a fifth embodiment of the present invention.

FIG. 6 is a plan view schematically illustrating a substrate of a recording head according to a sixth embodiment of the present invention.

FIG. 7 is a plan view illustrating the recording head using the substrate according to the sixth embodiment.

FIG. 8 is a perspective view illustrating an inkjet recording apparatus according to an embodiment of a liquid discharge apparatus of the present invention.

### DESCRIPTION OF THE EMBODIMENTS

According to an embodiments of the present invention, even if an electrochemical reaction accompanying an electrical leakage to an electroconductive protective film proceeds, an influence thereof is limited only to the electroconductive protective film and a heater in a group and, therefore, nozzles affected in a change in discharge characteristics, etc. can be limited.

Hereinafter, embodiments of the present invention are described in detail with reference to the drawings.

### First Embodiment

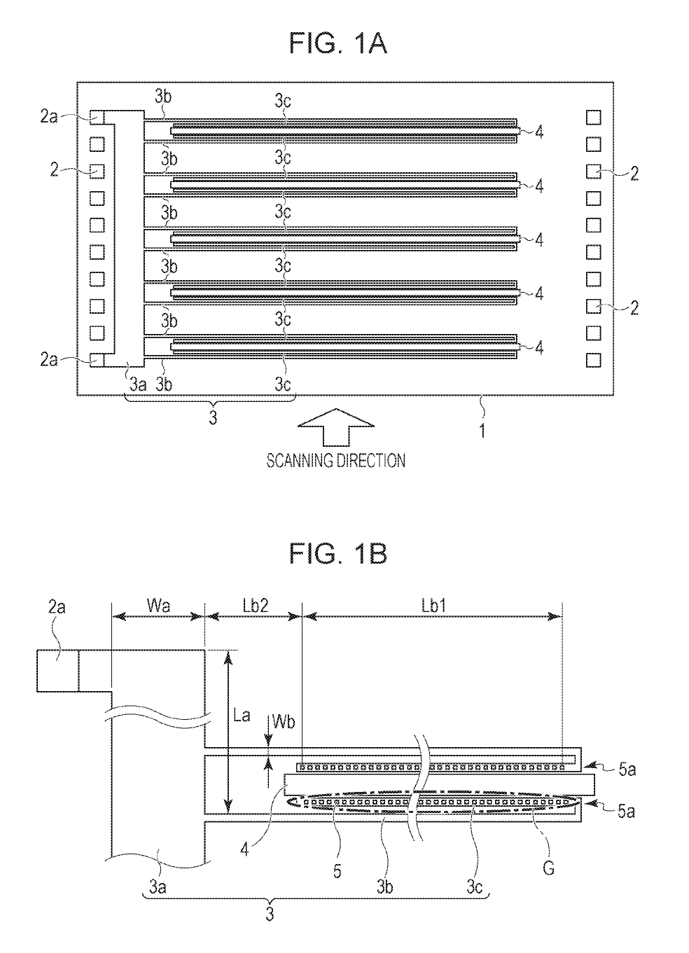

FIG. 1A is a plan view and FIG. 1B is an enlarged plan view schematically illustrating a substrate constituting an inkjet recording head according to a first embodiment of the present invention. In FIGS. 1A and 1B, a substrate 1 is provided with a pair of heater arrays in which a predetermined number of heaters 5 are arranged on both sides of an ink supply port 4. Five pairs of heater arrays 5a are provided each of which corresponds to each of five ink supply ports 4 provided in the substrate 1. Each of the five pairs of heater arrays 5a may, for example, correspond to each of different types of inks. A flow path forming member (not illustrated) in which nozzles are disposed corresponding to the heaters 5 of each heater array 5a is joined to the substrate 1, thereby constituting the recording head of the present embodiment. The recording head provided with the substrate 1 can record on a recording medium by scanning in a scanning direction illustrated in FIG. 1A.

Supply ports 4 in the substrate 1 are provided to penetrate the substrate 1. Therefore, ink can be supplied to pressure chambers each corresponding to each heater 5 provided on a front side of the substrate 1 from a liquid chamber on a back side via the ink supply ports 4. Plural electrode pads (terminals) are provided along sides of both ends of the substrate 1. Among these electrode pads, pads 2a of both ends in left pad arrays in FIG. 1A are used to check a leakage between an electroconductive protective film 3 and electrode wiring for driving the heaters described below. The electrode pads 2a are used also to apply a voltage so that the electroconductive protective film has a predetermined potential, and to limit an electrochemical reaction occurring between the electroconductive protective film 3 and ink upon occurrence of a leakage described later. Other electrode pads 2 are connected with electrode wiring (not illustrated) for driving the heaters 5 and, therefore, corresponding heaters 5 can be driven by driving signals supplied via the pads 2 depending on recording signals from a device control unit, and heat for discharging ink can be generated.

As illustrated in FIGS. 1A and 1B, the electroconductive protective film 3 of the present embodiment includes a relatively thick common pattern (common wiring) 3a which electrically connects with the pads 2a, and relatively thin plural wiring patterns (discrete wirings) 3b branching from the pattern 3a and electrically connecting with each of the plural heater arrays 5a. The electroconductive protective film 3 further includes protective patterns (protective films) 3c. Each branched wiring pattern 3b is connected with each protective pattern 3c. The protective pattern 3c protects upper surfaces of the plural heaters 5 (heater array 5a). The protective pattern 3c defines a group G of the plural heaters 5 or the heater array 5a. The heater array 5a on one side of the ink supply port 4 is considered as one group. That is, the protective patterns 3c define plural heater groups.

In the present embodiment, each of the plural heater arrays 5a constitutes the group G of the electroconductive protective film. The heater array 5a of each group G is connected with a common pattern 3a with relatively low electrical resistance (i.e., with a low sheet resistance value) via the wiring pattern 3b with relatively high electrical resistance (i.e., with a high sheet resistance value).

Comparison in the resistance values (sheet resistance values) in the pattern of the electroconductive protective film 3 is as follows. A width Lb1 of the heater array 5a is set to 0.5 inch (about 12.7 mm), and a distance Lb2 between one end of the heater array 5a and an end of the common pattern 3a is set to 500 μm. A width Wb of the pattern 3b is set to 10 μm. Then, a resistance value RA of the pattern 3b is (Lb1:12700+Lb2:500)/Wb:10=1320 sheet.

Next, a distance La of the common pattern 3a from the furthest end pattern 3b to an end portion at which the common pattern 3a connects with the pad 2a is set to 4 mm, and a width Wa is set to 500 μm. If a resistance value of a connecting portion to the pad 2a is ignored, a resistance value RB of the pattern 3a is La:4000/Wa:500=8 (sheet resistance value). Technically, the pattern 3a is connected with the two pads 2a, and the resistance value per pad corresponds to 4 sheets which are substantially half the number of 8 (sheet resistance value). A voltage of 0V is applied to these pads 2a by a device control unit.

In the present embodiment, with the relationship between the resistance values about the electroconductive protective film 3, even if voltage abnormality, such as a leakage, occurs in one group in the group G of the heater array, an influence on other groups can be reduced. For example, suppose that abnormality, such as a leakage, occurs in either of the heaters in one group G of the plural groups G, and a heater driving voltage VH conducts with the electroconductive protective film. Other heaters in the same group G may be affected by the voltage VH, and then an electrochemical reaction between the electroconductive protective film and the ink may proceed and a change in discharge characteristics and discharge abnormality may be caused. However, since each heater in other groups G is connected with the pad 2a of a potential of 0V via the pattern 3b with a small resistance value and the common pattern 3a for each group, an influence of a change in the potential of the group with abnormality is limited.

Specifically, when a leakage conducting to the driving voltage VH occurs in a heater in a certain group G, a potential of the common pattern 3a is applied to other groups G. This is because the wiring pattern 3b branched from the common pattern 3a is independently wired with respect to the corresponding group G. Suppose that the electroconductive protective film 3c on a certain heater has a VH potential due to a leakage, a maximum potential of the common pattern 3a can be expressed by the following Expression based on each resistance value described above:

VH×RB/(RB+RA).

### If VH is set to 24V,

24V×4/(4+1320)=0.073V.

That is, in the above example, a voltage which affects other groups G is equal to or smaller than 0.073V, which is relatively low as a voltage.

An electrochemical reaction between the electroconductive protective film and the ink does not proceed unless the voltage exceeds a certain value. Typically, a potential at which an electrochemical reaction between a film material and an ink material proceeds is shown by a Pourbaix diagram. That is, a state in which the electrochemical reaction does not proceed can be created by setting a voltage of a dead zone in the Pourbaix diagram. This is called a cathodic protection effect.

The voltage of the common pattern of the present embodiment desirably has the voltage of the dead zone. However, even if not the voltage of the dead zone, a voltage qualitatively close to the voltage of the dead zone can retard the progress of the reaction. Therefore, a constant effect is obtained.

There is a possibility that an electrochemical reaction may proceed in other heaters in the same group as the group of the heater in which voltage abnormality, such as a leakage, is occurring. To address this problem, an image defect can be avoided or reduced by complementing the recording by a heater array (a nozzle array) of other groups for which an influence has been reduced, for example.

In the present embodiment, the pads which electrically connect the pattern of the electroconductive protective film and the device control unit are provided at two positions in the substrate. However, one pad may also provide same effect basically. Regarding a leakage test, if there are two or more pads, it is possible to perform a leakage test after confirming a connected state between these pads. By disposing these two pads with a certain space therebetween in the substrate, resistance to the outside from the common pattern can be reduced, and a voltage affecting other groups upon occurrence of a leakage can be lowered.

### Second Embodiment

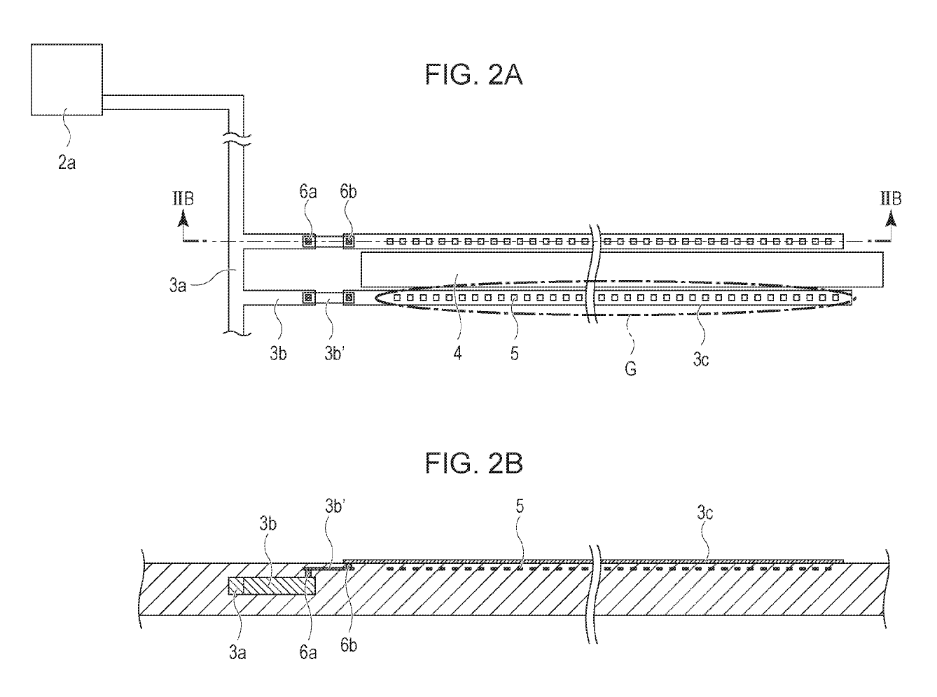

FIG. 2A is an enlarged view of a heater group G on a substrate of a recording head according to a second embodiment of the present invention and FIG. 2B is a cross-sectional view along line IIB-IIB. The present embodiment differs from the first embodiment in the following points: the patterns 3a, 3b and 3c are constituted by the same electroconductive protective film which is a metal film in the first embodiment, whereas a wiring pattern (discrete wiring) 3b and a common pattern (common wiring) 3a are constituted using different metal layers in the present embodiment.

As illustrated in FIGS. 2A and 2B, a protective pattern (protective film) 3c of an electroconductive protective film which protects upper surfaces of heaters is connected with a metal layer 3b′ of a high resistance value constituted by a heater layer via a via 6b. The high resistance metal layer 3b′ is further connected with a wiring layer (discrete wiring) 3b and a common wiring 3a with a sheet resistance value lower than that of the high resistance metal layer 3b′ via a via 6a.

According to the present embodiment, a relationship of desired resistance values can be realized in a smaller substrate area or a narrower layout pattern width by using a high resistance metal layer and a wiring layer having low sheet resistance of different layers.

### Third Embodiment

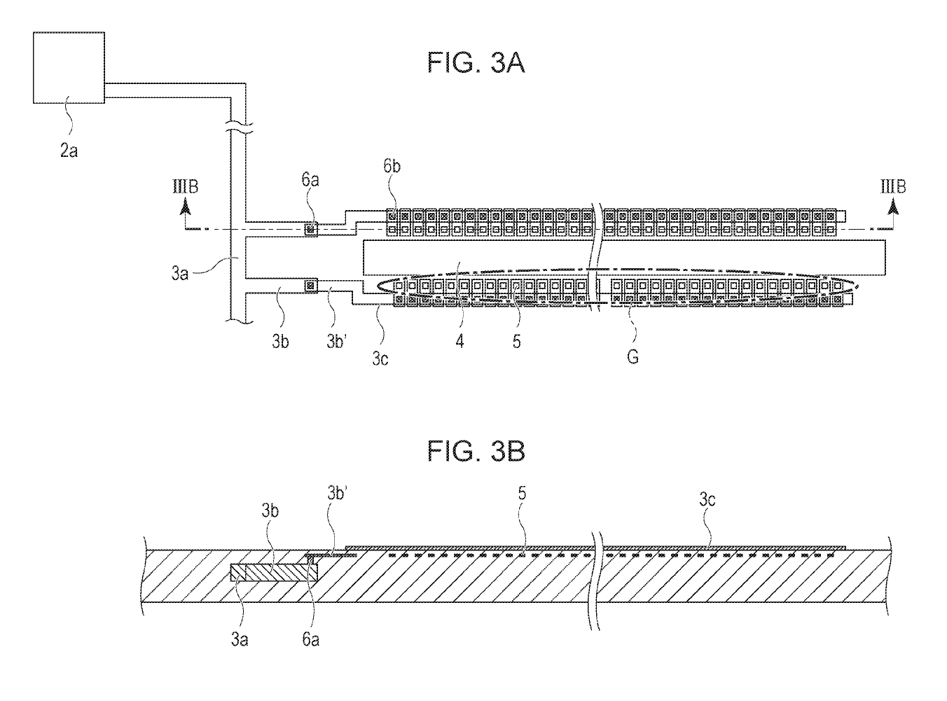

FIG. 3A is an enlarged view of a heater group G on a substrate of a recording head according to a third embodiment of the present invention and FIG. 3B is a cross-sectional view along line IIIB-IIIB. The electroconductive protective film 3c which protects the upper surfaces of the heaters forms continuously connected patterns in the same group G in the second embodiment, whereas an electroconductive protective film 3c is connected with a metal layer 3b′ of a high resistance value via a via 6b provided corresponding to each heater, while forming other individual patterns of a conductive layer corresponding to each heater in the present embodiment. The metal layer 3b′ is further connected with a wiring layer 3b and a common wiring 3a via a via 6a.

According to the present embodiment, further lowering of the voltage which affects other groups upon occurrence of a leakage becomes easier by setting a length of the wiring by the high resistance metal layer 3b′ to be longer.

### Fourth Embodiment

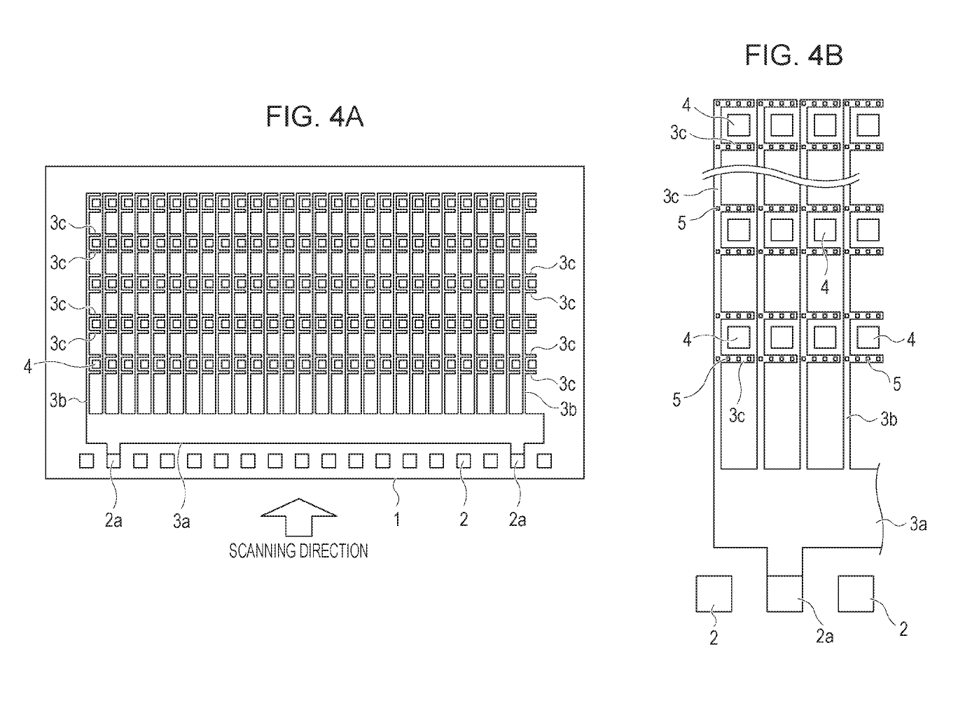

FIG. 4A is a plan view and FIG. 4B is an enlarged plan view schematically illustrating a substrate of a recording head according to a fourth embodiment of the present invention. In a substrate according to the present embodiment, plural ink supply ports 4 are arranged two-dimensionally and heaters 5 are arranged in an array on both sides of the ink supply ports 4. In the substrate 1, pads 2 and 2a are arranged along one side of the substrate 1 parallel to a nozzle array.

A pattern of an electroconductive protective film 3 is connected with a common pattern 3a of relatively thick width connected with the electrode pads 2a and connected with individual patterns 3b of relatively thin widths independently connected with the plural heater arrays. The individual patterns 3b are connected with the electroconductive protective film 3c which protects upper surfaces of the plural heaters 5.

In the present embodiment, in one protective film 3c, a heater group of the heaters 5 corresponding to the ink supply ports 4 arranged in a direction perpendicularly crossing an arranging direction of the nozzles corresponding to the heaters 5 (i.e., a scanning direction illustrated in FIG. 4A) is considered as one group G. That is, four heaters 5 are disposed above and below each ink supply port 4 and arranged in the direction perpendicularly crossing the scanning direction as illustrated in FIG. 4B. The group of the heaters is defined by covering, with one pattern 3c of the electroconductive protective film, these above and below heater arrays arranged corresponding to one ink supply port 4 in the scanning direction. Thus, in the present embodiment, the ink supply ports 4 are arranged two-dimensionally and the pattern 3c of the electroconductive protective film is laid between adjacent ink supply ports 4 in the substrate 1.

According to the present embodiment, if abnormality occurs in one of the heaters in the group G defined by the pattern 3c and a driving voltage VH of the heater conducts with the electroconductive protective film, heaters in the same group G are affected by the VH potential. As a result, an electrochemical reaction between the electroconductive protective film and the ink proceeds and a change in discharge characteristics and discharge abnormality may be caused. However, the influence of the voltage is connected with a pad 2a of 0V via the discrete wiring 3b corresponding to the group and the common wiring 3a, whereby the influence on other groups G are reduced.

In the first embodiment, since the group is formed on a nozzle array basis, if conduction with a VH potential occurs in at least one group, all of the nozzles (heaters) in the array in the group may be affected. On the contrary, according to the present embodiment, the range to be affected can be limited to the unit of the ink supply ports 4 of a predetermined number.

### Fifth Embodiment

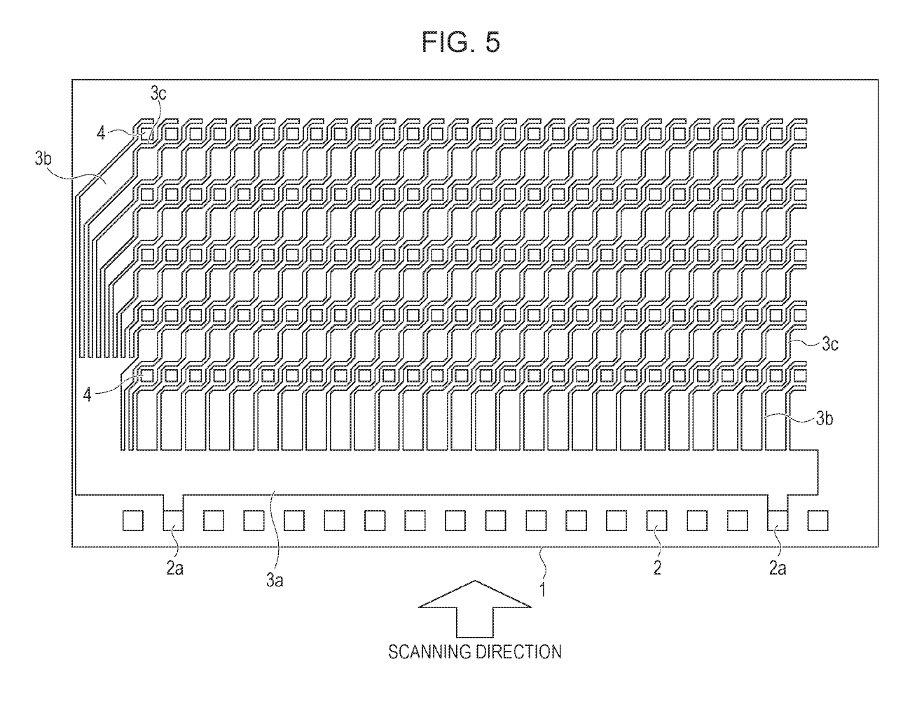

FIG. 5 is a plan view schematically illustrating a substrate of a recording head according to a fifth embodiment of the present invention. In the fourth embodiment, groups are defined by the electroconductive protective film 3c in the direction perpendicularly crossing the direction of the nozzle array. In the present embodiment, groups are defined in an oblique direction. In particular, as illustrated in FIG. 5, a part of a wiring pattern 3b branched from a common pattern 3a is obliquely wired. With this configuration, with respect to the two-dimensionally arranged ink supply ports 4 and a corresponding heater group, the protective film 3c protects the obliquely arranged heater group (corresponding to the ink supply ports 4), and defines a group of the heater group.

According to the present embodiment, the unit of the group affected by the conduction with the VH potential can be shifted sequentially with respect to the relative moving direction (i.e., the scanning direction) to the recording medium of the recording head. Therefore, the influence of the leakage with respect to the recording area can further be reduced.

### Sixth Embodiment

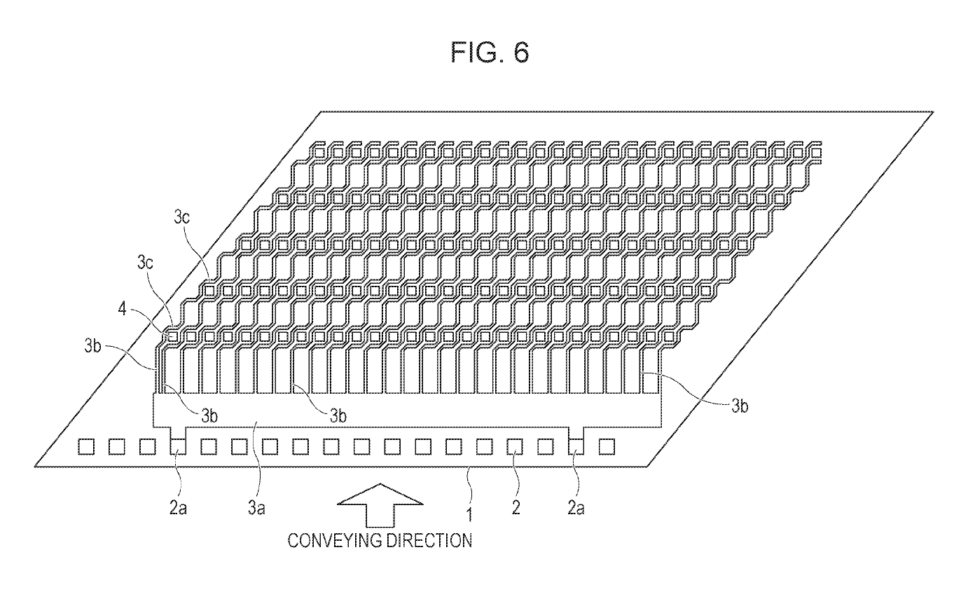

FIG. 6 is a plan view schematically illustrating a substrate of a recording head according to a sixth embodiment of the present invention. In the present embodiment, groups defined by the electroconductive protective film 3c in the same manner as in the fifth embodiment are defined in an oblique direction (i.e., offset), and an outer shape of a chip (i.e., a substrate) is aligned in the oblique direction. That is, in an outer shape of the substrate 1, two facing sides do not cross perpendicularly. Therefore, the same separation pattern of the electroconductive protective film can be implemented in all the group units. That is, separation resistance is unequal partially in the electroconductive protective film 3c in the fifth embodiment, whereas separation resistance becomes equal in the entire region of the substrate in the present embodiment.

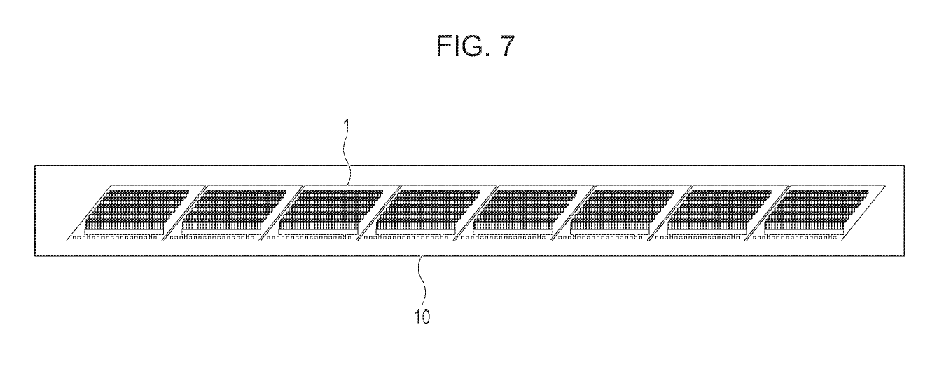

FIG. 7 is a plan view schematically illustrating the recording head of the present embodiment in which plural substrates according to the present embodiment are arranged. As illustrated in FIG. 7, parallelogrammatic chips (substrates) are arranged substantially linearly. By conveying a recording medium in the conveying direction illustrated in FIG. 6 with respect to the elongated recording head 10, recording can be performed on the recording medium. An effect of limiting an influence by conduction between an electroconductive protective film and a heater potential is large in such an elongated head. That is, even if at least one of plural chips in the recording head becomes defective, a possibility that the entire recording head in which plural chips are arranged becomes defective can be lowered.

### Liquid Discharge Apparatus

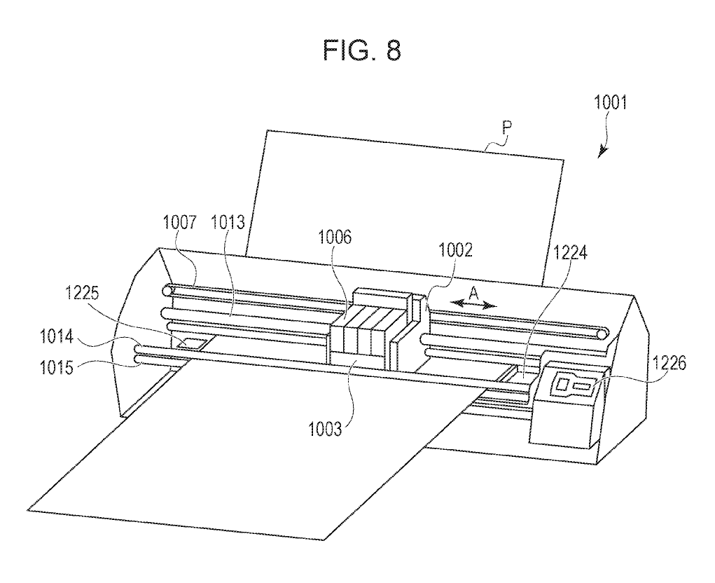

FIG. 8 is a perspective view illustrating an inkjet recording apparatus according to an embodiment of a liquid discharge apparatus of the present invention. In a carriage 1002 of an inkjet recording apparatus 1001, a recording head 1003 as a liquid discharge head, and an ink cartridge 1006 which stores ink to be supplied to the recording head 1003 are mounted removably. The recording head 1003 and the ink cartridge 1006 may be formed integrally with each other. The ink cartridges 1006 are prepared for the ink of magenta (M), cyan (C), yellow (Y) and black (K). These four ink cartridges 1006 are mounted on the carriage 1002.

When mounted on the carriage 1002, the recording head 1003 is electrically connected with an apparatus main body via each electrical connection portion (i.e., each pad 2 of the recording head). Therefore, the recording head 1003 can perform operations, such as discharge of ink, in response to a recording signal from the apparatus main body. The recording head 1003 can be constituted using the substrate according to the first to the fifth embodiments described above.

In the inkjet recording apparatus 1001, a guide shaft 1013 is disposed to extend along a main scanning direction of the carriage 1002. The carriage 1002 is slidably supported by the guide shaft 1013. Therefore, a motion of the carriage 1002 along the guide shaft 1013 in the direction of arrow A is guided. Driving force of a carriage motor is transmitted to the carriage 1002 via a drive belt 1007 as a transmission mechanism, whereby the carriage 1002 can reciprocate. With the above configuration, since the ink is discharged while the recording head 1003 scans in the main scanning direction, recording is performed in the entire width of a recording medium P on a platen. The recording medium P can be conveyed in the conveying direction by a conveyance roller 1014 driven by an unillustrated conveyance motor and pinch rollers 1015 which bring the recording medium P in contact with the conveyance roller 1014.

At an end portion of an moving region of the recording head 1003, a cap 1226 which caps the nozzle and can receive the ink discharged from the recording head 1003 is disposed. The ink discharged in preliminary discharge can be collected in the following manner: in a state where the nozzle of the recording head 1003 is capped, preliminary discharge with pigment ink is performed inside the cap 1226 and the ink is sucked in the cap. Outside a conveying path of the recording medium P, a platen preliminary discharge position home 1224 and a platen preliminary discharge position away 1225 at which ink can be received when the preliminary discharge is performed on the platen are disposed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-254285, filed Dec. 25, 2015, which is hereby incorporated by reference herein in its entirety.

What is claimed is:

1. A liquid discharge head which discharges a liquid, comprising:
a substrate on which plural heaters configured to generate heat for discharging a liquid are provided;
an electroconductive protective film configured to cover the plural heaters and define a group consisting of the covered plural heaters in the substrate;
a discrete wiring connected with the protective film for each group in the substrate;
a common wiring connected with the discrete wiring for each group in common; and
a terminal connected with the common wiring and configured to electrically connect the common wiring with an outside of the substrate,
wherein electrical resistance of the discrete wiring is higher than electrical resistance of the common wiring.

2. The liquid discharge head according to claim 1, wherein, when electrical resistance of the discrete wiring is denoted by RA, electrical resistance of the common wiring is denoted by RB, and a driving voltage of the heater is denoted by VH, a value expressed by
VH×RB/(RB+RA)
is a voltage in a dead zone in which an electrochemical reaction between a liquid and the electroconductive protective film does not proceed.

3. The liquid discharge head according to claim 1, wherein the protective film, the discrete wiring, and the common wiring are constituted by a common layer.

4. The liquid discharge head according to claim 1, wherein the protective film and at least a part of the discrete wiring are constituted by different layers.

5. The liquid discharge head according to claim 1, wherein the protective film, the discrete wiring, and the common wiring are constituted by different layers.

6. The liquid discharge head according to claim 1, wherein the protective film defines the group as a pattern in which common layers are connected continuously.

7. The liquid discharge head according to claim 1, wherein the protective film defines the group by electrically connecting a pattern of a predetermined layer with a different conductive layer.

8. The liquid discharge head according to claim 1, further comprising plural heater arrays each constituted by plural heaters arranged in an array, wherein the group is formed on the heater array basis.

9. The liquid discharge head according to claim 1, further comprising plural supply ports for supplying a liquid to a pressure chamber in which the heater is provided, wherein,
in the group, the protective film is provided across plural arrays of the supply ports, and the protective film is disposed between supply ports included in the same array of the supply port.

10. The liquid discharge head according to claim 9, wherein the group provided across plural arrays of the supply ports are offset with respect to relative moving directions of a medium and the liquid discharge head.

11. The liquid discharge head according to claim 10, wherein, in an outer shape of the substrate, two facing sides do not cross perpendicularly.

12. The liquid discharge head according to claim 1, wherein the plural substrates are disposed side by side.

13. The liquid discharge head according to claim 1, wherein plural terminals are connected with the common wiring.

14. The liquid discharge head according to claim 13, wherein plural terminals are disposed with another terminal disposed therebetween.

15. A liquid discharge apparatus provided with a liquid discharge head which discharges a liquid, comprising:
a substrate on which plural heaters configured to generate heat for discharging a liquid are provided;
an electroconductive protective film configured to cover the plural heaters and define a group consisting of the covered plural heaters in the substrate;
a discrete wiring connected with the protective film for each group in the substrate;
a common wiring connected with the discrete wiring for each group in common; and
a terminal connected with the common wiring and configured to electrically connect the common wiring with an outside of the substrate,
wherein electrical resistance of the discrete wiring is higher than electrical resistance of the common wiring.

16. A liquid discharge head which discharges a liquid comprising:
a substrate on which a first heater and a second heater configured to generate heat for discharging a liquid are provided;
an electroconductive first protective film configured to cover the first heater;
an electroconductive second protective film configured to cover the second heater;
a first discrete wiring connected with the first protective film;
a second discrete wiring connected with the second protective film;
a common wiring connected in common with the first discrete wiring and the second discrete wiring and having electrical resistance lower than those of the first discrete wiring and the second discrete wiring; and
a terminal connected with the common wiring and configured to electrically connect the common wiring with an outside of the substrate.

17. The liquid discharge head according to claim 16, wherein, when electrical resistance of the first discrete wiring is denoted by RA, electrical resistance of the common wiring is denoted by RB, and a driving voltage of the first heater is denoted by VH, a value expressed by
VH×RB/(RB+RA)
is a voltage in a dead zone in which an electrochemical reaction between a liquid and the first protective film does not proceed.

18. The liquid discharge head according to claim 16, wherein the first protective film and at least a part of the first discrete wiring are constituted by different layers, and the second protective film and at least a part of the second discrete wiring are constituted by different layers.

19. The liquid discharge head according to claim 16, wherein the first protective film covers a first heater array in which the plural first heaters are arranged, the second protective film covers a second heater array in which the plural second heaters are arranged, and
directions of the first heater array and the second heater array are inclined with respect to relative moving directions of a medium to which a liquid is discharged and the liquid discharge head.
